(19) United States
(12) Patent Application Publication
(10) Pub. No.: US 2008/0238866 A1
(43) Pub. Date: Oct. 2, 2008

(54) Drawing circuit of electro-optical display device, drawing method of electro-optical display device, electro-optical display device, and electronic apparatus

(75) Inventor: Hidetoshi Saito, Suwa-shi (JP)

Correspondence Address: ADVANTEDGE LAW GROUP, LLC, 3301 NORTH UNIVERSITY AVE., SUITE 200, PROVO, UT, 84604, US

(73) Assignee: Seiko Epson Corporation, Tokyo (JP)

(21) Appl. No.: 12/075,885

(22) Filed: Mar. 15, 2008

(30) Foreign Application Priority Data
Mar. 30, 2007 (JP) 2007-090961

(51) Int. Cl. G09G 3/34

(52) U.S. Cl. 345/107

(57) ABSTRACT

Provided is a drawing device of an electro-optical display device which includes a drawing circuit for outputting image data to a driving circuit for driving electro-optical elements of a display unit for displaying an image based on the image data, and a control circuit for controlling the drawing circuit, wherein the drawing circuit includes a first memory in which a plurality of image material data is previously stored, a first working memory having a working area in which the image data composed of at least one image material data is generated, a second working memory having a command information area in which a command signal for instructing execution of a predetermined process is written, and a drawing control circuit which writes the command signal in the command information area and generates command information composed of a plurality of command signals in the command information area, and the control circuit outputs a first control command signal for executing the command information to the drawing control circuit.

### BACKGROUND

1. Technical Field

The present invention relates to a drawing circuit of an electro-optical display device, a drawing method of the electro-optical display device, the electro-optical display device, and an electronic apparatus.

2. Related Art

As an electro-optical display device, an electrophoretic display device using an electrophoretic display phenomenon is known (for example, see JP-A-2002-116733). The electrophoretic display phenomenon indicates that, when an electric field is applied to a dispersion system in which particles (electrophoretic particles) are dispersed in liquid (dispersion medium), the particles migrate by Coulomb force.

Such an electrophoretic display device includes an electrophoretic display panel, in which an electrode and another electrode face each other at a predetermined gap and division cells having a dispersion system sealed therein are interposed therebetween, and a peripheral circuit for applying an electric field to the dispersion system and driving the dispersion system.

As a driving method of the electrophoretic display device, an active matrix method is known. As shown in FIG. 20, an electrophoretic display panel 10 of an electrophoretic display device of this type includes a device substrate 2, in which pixel electrodes P and pixel circuits 20 (see FIG. 21) each including a switching TFT are formed in a matrix, and a counter substrate 3 in which a common electrode COM formed of a flat transparent electrode is formed of a transmissive material. A plurality of micro capsules 4 in which electrophoretic particles 5 and a dispersion medium 6 are sealed are interposed between the plurality of pixel electrodes P and the common electrode COM. In FIG. 20, as the electrophoretic particles 5, white particles 5W charged with a negative polarity and black particles 5B charged with a positive polarity are used.

When a voltage difference occurs between the pixel electrodes P and the common electrode COM, an electric field occurs and the black particles 5B or white particles 5W charged with the positive or negative polarity are led to electrodes to which corresponding voltages are applied. If a display image is observed from the common electrode COM and the counter substrate 3, the colors of the electrophoretic particles 5 led to the side of the common electrode COM are observed.

As shown in FIG. 21, the electrophoretic display device includes the electrophoretic display panel 10, a driving circuit for driving the electrophoretic display panel 10, a drawing circuit 50 for controlling the driving circuit, and a microcomputer 60 for controlling the drawing circuit 50.

In the electrophoretic display device, a drawing control circuit 51 of the drawing circuit 50 reads predetermined image material data, which is previously stored in a ROM 52, and writes the image material data in a VRAM 53, on the basis of a command from the microcomputer 60. When desired image data D composed of at least one image material data is generated in the VRAM 53, the drawing control circuit 51 supplies the image data D to a data line driving circuit 12, on the basis of a command from the microcomputer 60. When the image data D is output from the VRAM 53, the timing control circuit 54 outputs various types of timing signals to a scan line driving circuit 11 and the data line driving circuit 12.

The scan line driving circuit 11 outputs scan signals for sequentially selecting scan lines Y at predetermined timings to the scan lines Y, on the basis of the timing signals. In contrast, the data line driving circuit 12 generates data signals on the basis of the input image data D and outputs the data signals to the pixel circuits 20 corresponding thereto in synchronization with the selection of the scan lines.

Next, when a value of a power supply voltage is set by the drawing control circuit 51 on the basis of a command from the microcomputer 60, in the pixel circuits 20, a driving voltage according to the data signals (image data D1) is applied to the pixel electrodes P. At this time, the voltage applied to the common electrode COM is controlled by the drawing control circuit 51 on the basis of a command from the microcomputer 60 and a predetermined voltage is applied to the common electrode COM. Accordingly, a voltage difference occurs between the pixel electrodes P and the common electrode COM such that the electrophoretic particles 5 move toward desired electrodes in each of the pixel circuits 20. As a result, an image based on the image data D is displayed on the electrophoretic display panel 10.

As described above, the microcomputer 60 of the electrophoretic display device outputs corresponding commands to the drawing control circuit 51 in order to allow the drawing control circuit 51 to perform a variety of processes such as the generation of the image data D in the VRAM 53, the transmission of the image data D to the data line driving circuit 12, and the control of various voltages. In more detail, the microcomputer 60 outputs a command for performing a predetermined process to the drawing control circuit 51. The drawing control circuit 51 performs a predetermined process, for example, a process of writing predetermined image material data stored in the ROM 52 in the VRAM 53, on the basis of the command and outputs a completion signal to the microcomputer 60 when the process is completed. The microcomputer 60 receives the completion signal and outputs a command for performing a next process to the drawing control circuit 51. In this electrophoretic display device, a variety of processes for displaying a desired image is instructed by the commands of the microcomputer 60.

However, if the electrophoretic display image applies to an electronic apparatus (for example, a wristwatch) including only the microcomputer 60 having a low processing capability for low power consumption (for example, 4-bit microcomputer having an operation frequency of 32 kHz), a load of the microcomputer 60 is large. Thus, it takes much time to change a display image.

### SUMMARY

An advantage of some aspects of the invention is that it provides a drawing circuit of an electro-optical display device, a drawing method of the electro-optical display device, the electro-optical display device and an electronic apparatus, which are capable of reducing a load of a control circuit for controlling the drawing circuit.

According to an aspect of the invention, there is provided a drawing device of an electro-optical display device which includes a drawing circuit for outputting image data to a driving circuit for driving electro-optical elements of a display unit for displaying an image based on the image data, and a control circuit for controlling the drawing circuit, wherein the drawing circuit includes a first memory in which a plurality of image material data is previously stored, a first working memory having a working area in which the image data composed of at least one image material data is generated, a second working memory having a command information area in which a command signal for instructing execution of a predetermined process is written, and a drawing control circuit which writes the command signal in the command information area and generates command information composed of a plurality of command signals in the command information area, and the control circuit outputs a first control command signal for executing the command information to the drawing control circuit.

In the known electro-optical display device, a completion signal indicating that the execution of the process based on the command signal is completed is input from the drawing control circuit to the control circuit in each command signal. Accordingly, the load of the control circuit is increased.

In contrast, according to the drawing device of the electro-optical display device of the invention, the command information composed of the plurality of command signals is generated in the command information area of the second working memory, and the command information is executed by the drawing control circuit on the basis of the control command signal output from the control circuit. Accordingly, the plurality of command signals configuring the command information are continuously executed. Thus, the completion signal is input from the drawing control circuit to the control circuit in command information composed of the plurality of command signals. Accordingly, since the number of times of input of the completion signal to the control circuit is reduced, the load of the control circuit is reduced. Further, a time for changing a display image can be shortened.

In the drawing device of the electro-optical display device, the drawing control circuit may write the command signal received from the control circuit in the command information area, on the basis of a second control command signal received from the control circuit.

According to the drawing device of the electro-optical display device, the command signal input from the control circuit to the drawing control circuit is written in the command information area of the second working memory as the command information.

In the drawing device of the electro-optical display device, the drawing control circuit may write the command signal from the control circuit in any area of the command information area, on the basis of the second control command signal.

According to the drawing device of the electro-optical display device, the command signal input from the control circuit to the drawing control circuit can be written in any area of the command information area of the second working memory. Accordingly, a portion of the command information which is first stored in the command information area can be rewritten with a predetermined command signal. Before or after the command information which is first written, a predetermined command signal can be further written.

In a case where the process is performed with respect to each command signal, all corresponding commands need to be output from the control circuit in order to perform a desired process. In contrast, by this configuration, for example, only a different signal between the command information which is first written and the command information which is next written is output from the control circuit such that a portion of the command information is rewritten, thereby performing the desired process. Accordingly, it is possible to remarkably reduce the load of the control circuit.

In the drawing device of the electro-optical display device, the plurality of command signals are previously stored in the first memory, and the drawing control circuit writes the predetermined command signal stored in the first memory in the command information area, on the basis of a second control command signal received from the control circuit.

According to the drawing device of the electro-optical display device, the plurality of command signals are previously stored in the first memory. The command signal stored in the first memory is written in the command information area of the second working memory as the command information, on the basis of the second control command signal from the control circuit. Accordingly, it is possible to reduce the number of command signals stored in the memory of the control circuit having a small memory size and having a command signal stored therein.

In the drawing device of the electro-optical display device, the drawing control circuit may write the predetermined command signal stored in the first memory in any area of the command information area, on the basis of the second control command signal.

According to the drawing device of the electro-optical display device, the command signal which is previously stored in the first memory can be written in any area of the command information area on the basis of the second control command signal. Accordingly, a portion of the command information which is first written in the command information area can be rewritten with a predetermined command signal. Before or after the command information which is first written, a predetermined command signal can be further written. Accordingly, it is possible to improve a freedom degree of the method of generating the command signal.

In the drawing device of the electro-optical display device, plural pieces of command information which are previously generated may be previously stored in the first memory, and the drawing control circuit may write the predetermined command information stored in the first memory in the command information area, on the basis of a third control command signal received from the control circuit.

According to the drawing device of the electro-optical display device, the plural pieces of command information composed of the plurality of command signals are previously stored in the first memory. The command information stored in the first memory is written in the command information area of the second working memory on the basis of the third control command signal from the control circuit. Accordingly, the plurality of command signals can be written in the command information area by one third control command signal from the control circuit. Accordingly, since the amount of data output from the control circuit to the drawing control circuit can be reduced, it is possible to remarkably reduce the load of the control circuit.

In the drawing device of the electro-optical display device, the drawing control circuit may write the predetermined command information stored in the first memory in any area of the command information area, on the basis of the third control command signal.

According to the drawing device of the electro-optical display device, the command information which is previously stored in the first memory can be written in any area of the command information area, on the basis of the third control command signal. Accordingly, it is possible to improve a freedom degree of the method of generating the command signal.

In the drawing device of the electro-optical display device, the control circuit may output the first control command signal after the command information composed of all the command signals for displaying a predetermined image is generated in the command information area.

According to the drawing device of the electro-optical display device, when the first control command signal is output from the control circuit, all the command signals for displaying a predetermined image are continuously executed. Accordingly, when the process for displaying the predetermined image is executed in the drawing control circuit, another process can be executed in the control circuit. At this time, it is possible to reduce power consumption of the drawing device by setting the control circuit to a sleep state which is a low power consumption mode.

In the drawing device of the electro-optical display device, the first working memory and the second working memory may be configured by one working memory. According to the drawing device of the electro-optical display device, one working memory includes a working area in which the image data composed of the at least one image material data is generated and a command information area in which the command signal for instructing the execution of a predetermined process is written.

In the drawing device of the electro-optical display device, the display unit may include a plurality of scan lines, a plurality of data lines, and a plurality of pixel circuits which are provided in correspondence with intersections between the plurality of scan lines and the plurality of data lines and respectively include the electro-optical elements.

According to the drawing device of the electro-optical display device, it is possible to supply the image data for displaying a desired image to the active matrix type display unit.

In the drawing device of the electro-optical display device, the electro-optical element is a dispersion system including electrophoretic particles.

According to the drawing device of the electro-optical display device, it is possible to supply the image data for displaying a desired image to the display unit of the electrophoretic display device.

According to another aspect of the invention, there is provided a drawing method of an electro-optical display device which includes a display unit which includes electro-optical elements and displays an image based on image data, a driving circuit for driving the display unit, a drawing circuit for outputting the image data to the driving circuit, and a control circuit for controlling the drawing circuit, wherein: a drawing control circuit of the drawing circuit writes a command signal for instructing execution of a predetermined process in a command information area of a working memory of the drawing circuit, and generates command information composed of a plurality of command signals in the command information area, and the control circuit outputs a first control command signal for executing the command information to the drawing control circuit.

According to the drawing method of the electro-optical display device, the command information composed of the plurality of command signals is generated in the command information area of the second working memory, and the command information is executed by the drawing control circuit on the basis of the control command signal output from the control circuit. Accordingly, the plurality of command signals configuring the command information are continuously executed. Thus, the completion signal is input from the drawing control circuit to the control circuit in command information composed of the plurality of command signals. Accordingly, since the number of times of input of the completion signal to the control circuit is reduced, the load of the control circuit is reduced. Further, a time for changing a display image can be shortened.

In the drawing method of the electro-optical display device, the drawing control circuit may write the command signal received from the control circuit in the command information area, on the basis of a second control command signal received from the control circuit.

According to the drawing method of the electro-optical display device, the command signal input from the control circuit to the drawing control circuit is written in the command information area of the second working memory as the command information.

In the drawing method of the electro-optical display device, the drawing control circuit may write the command signal received from the control circuit in any area of the command information area, on the basis of the second control command signal.

According to the drawing method of the electro-optical display device, the command signal input from the control circuit to the drawing control circuit can be written in any area of the command information area of the second working memory. Accordingly, a portion of the command information which is first stored in the command information area can be rewritten with a predetermined command signal. Before or after the command information which is first written, a predetermined command signal can be further written.

In a case where the process is performed with respect to each command signal, all corresponding commands need to be output from the control circuit in order to perform a desired process. In contrast, by this configuration, for example, only a different signal between the command information which is first written and the command information which is next written is output from the control circuit such that a portion of the command information is rewritten, thereby performing the desired process. Accordingly, it is possible to remarkably reduce the load of the control circuit.

In the drawing method of the electro-optical display device, the drawing control circuit may write the predetermined command signal, which is previously stored in a first memory of the drawing circuit, in the command information area, on the basis of a third control command signal received from the control circuit.

According to the drawing method of the electro-optical display device, the plurality of command signals are previously stored in the first memory. The command signal stored in the first memory is written in the command information area of the second working memory as the command information, on the basis of the second control command signal from the control circuit. Accordingly, it is possible to reduce the number of command signals stored in the memory of the control circuit having a small memory size and having a command signal stored therein.

In the drawing method of the electro-optical display device, plural pieces of command information composed of the plurality of command signals may be previously stored in a first memory of the drawing circuit, and the drawing control circuit may write the predetermined command information stored in the first memory in the command information area, on the basis of a third control command signal received from the control circuit.

According to the drawing method of the electro-optical display device, the plural pieces of command information composed of the plurality of command signals are previously stored in the first memory. The command information stored in the first memory is written in the command information area of the second working memory on the basis of the third control command signal from the control circuit. Accordingly, the plurality of command signals can be written in the command information area by one third control command signal from the control circuit. Accordingly, since the amount of data output from the control circuit to the drawing control circuit can be reduced, it is possible to remarkably reduce the load of the control circuit.

An electrophoretic display device of the invention includes the drawing device.

According to the electrophoretic display device of the invention, a time for changing a display image is shortened.

An electronic apparatus of the invention includes all apparatuses including the electrophoretic display device and includes a display device, a television device, an electronic book, an electronic paper, a watch, a calculator, a mobile phone, a personal digital assistant and so on. In addition, the electronic apparatus of the invention includes a concept other than the “apparatus”, for example, a flexible object having a paper shape/film shape, an immovable estate such as a wall to which the object is attached, and a mobile object such as a vehicle, an air vehicle, a ship or the like.

### BRIEF DESCRIPTION OF THE DRAWINGS

The invention will be described with reference to the accompanying drawings, wherein like numbers reference like elements.

FIG. 1 is a block diagram showing the overall configuration of an electrophoretic display device.

FIG. 2 is a table showing control commands according to a first embodiment of the invention.

FIG. 3 is a table showing commands according to the first embodiment of the invention.

FIG. 4 is a block diagram showing a working memory according to the first embodiment of the invention.

FIG. 5 is a block diagram showing a ROM according to the first embodiment of the invention.

FIG. 6 is a flowchart showing a method of generating a command macro according to the first embodiment of the invention.

FIG. 7 is a block diagram showing the command macro.

FIGS. 8A and 8B are plan views showing images displayed on the electrophoretic display panel.

FIGS. 9A to 9F are plan views showing images corresponding to a background block and part blocks.

FIG. 10 is a flowchart showing a method of executing the command macro.

FIGS. 11A and 11B are block diagrams showing a method of transmitting image data.

FIGS. 12A and 12B are timing charts when the command macro is executed.

FIG. 13 is a flowchart showing a method of correcting the command macro according to the first embodiment of the invention.

FIG. 14 is a block diagram showing the command macro.

FIG. 15 is a block diagram showing a ROM according to a second embodiment of the invention.

FIGS. 16A and 16B are block diagrams showing division command macros.

FIG. 17 is a table showing a control command according to the second embodiment of the invention.

FIG. 18 is a flowchart showing a method of generating the command macro according to the second embodiment of the invention.

FIG. 19 is a flowchart showing the method of generating the command macro according to the second embodiment of the invention.

FIG. 20 is a cross-sectional view showing a known electrophoretic display panel.

FIG. 21 is a block diagram showing the overall configuration of the known electrophoretic display panel.

### DESCRIPTION OF EXEMPLARY EMBODIMENTS

### First Embodiment

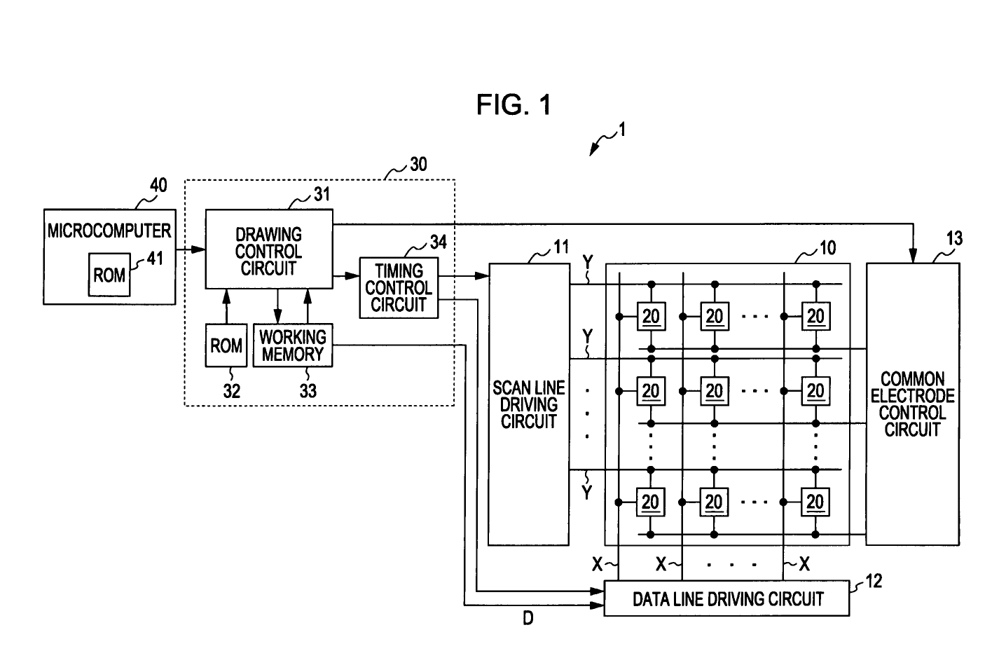

Hereinafter, an electrophoretic display device according to a first embodiment of the invention will be described with reference to FIGS. 1 to 14.

As shown in FIG. 1, an electrophoretic display device 1 includes an electrophoretic display panel 10 which is equal to that shown in FIG. 20, a driving circuit for driving the electrophoretic display panel 10, a drawing circuit 30 for controlling the driving circuit, and a microcomputer 40 for controlling the electrophoretic display device 1. In the present embodiment, the electrophoretic display device 1 which is used as a display unit of a wristwatch including a microcomputer having a low processing capability will be exemplarily described.

The electrophoretic display panel 10 includes pixel circuits 20 arranged in a matrix. That is, the pixel circuits 20 are arranged at intersections between a plurality of data lines X which extend in a column direction (a vertical direction of FIG. 1) and a plurality of scan lines Y which extend in a row direction (a horizontal direction of FIG. 1). Although not shown, each of the pixel circuits 20 includes a switching element, a memory circuit composed of a SRAM or a pixel electrode P (see FIG. 20). The electrophoretic display panel 10 according to the present embodiment includes 216 data lines X, 256 scan lines Y, and 55296(216×256) pixel circuits 20. That is, the number of pixels of the electrophoretic display panel 10 is 55296.

The scan lines Y are connected to a scan line driving circuit 11 and the data lines X are connected to a data line driving circuit 12. A common electrode COM is formed on a counter substrate facing a device substrate on which the circuits 11, 12 and 20 are formed. The common electrode COM is connected to a common electrode control circuit 13.

The scan line driving circuit 11 outputs scan signals for sequentially selecting the scan lines Y at predetermined timings, on the basis of various types of timing signals output from the drawing circuit 30. The data line driving circuit 12 generates data signals supplied to the data lines X on the basis of image data output from the drawing circuit 30. The data line driving circuit 12 outputs the generated data signals to the pixel circuits 20 connected to the scan line Y selected by the scan line driving circuit 11, on the basis of the various type of timing signals output from the drawing circuit 30.

The common electrode control circuit 13 supplies a predetermined voltage to the common electrode COM, on the basis of a control signal output from the drawing circuit 30. The driving circuit is configured by the scan line driving circuit 11, the data line driving circuit 12 and the common electrode control circuit 13.

The drawing circuit 30 includes a drawing control circuit 31, a ROM 32 for storing a variety of image data, a working memory 33 composed of a SRAM and a timing control circuit 34 for generating various types of timing signals.

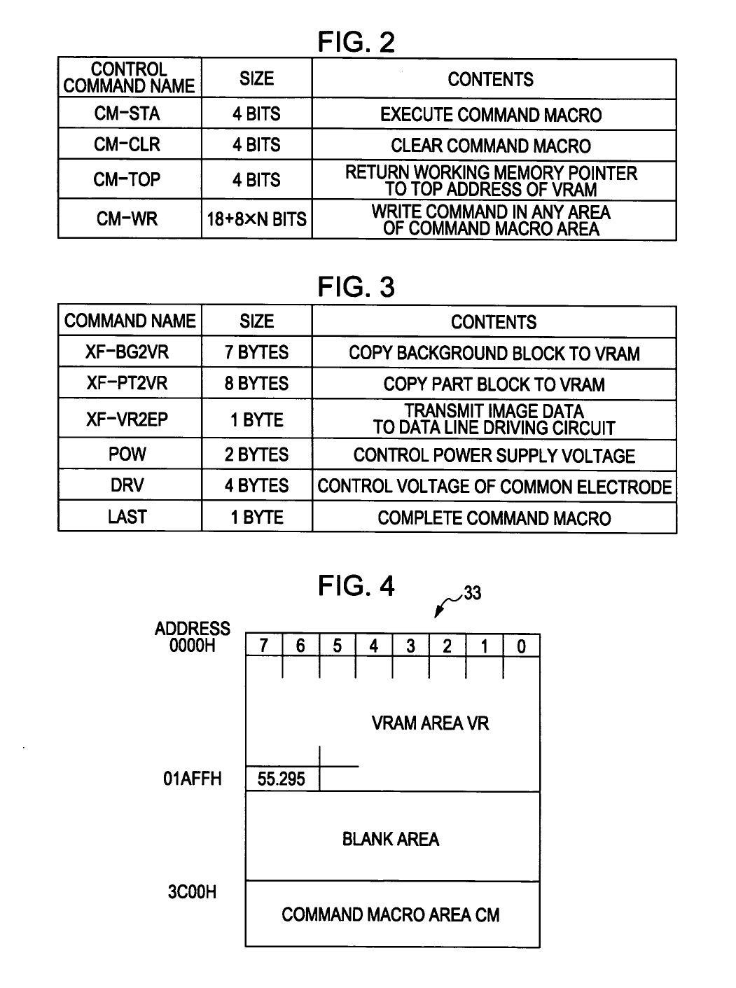

The drawing control circuit 31 is connected to the microcomputer 40 which is a high-level control device. The microcomputer 40 outputs a control command (see FIG. 2) stored in a microcomputer ROM 41 or a command (see FIG. 3) to the drawing control circuit 31, in order to display a display image according to an instruction due to the elapse of time or an instruction of a user of the wristwatch on the electrophoretic display panel 10.

The drawing control circuit 31 writes a command from the microcomputer 40 in a command macro area CM (see FIG. 4) of the working memory 33 and generates a command macro composed of a plurality of commands in the command macro area CM. Here, as shown in FIG. 4, the working memory 33 includes a VRAM area VR in which image data is written and the command macro area CM in which the various types of commands from the microcomputer 40 are written. Top addresses of the VRAM area VR and the command macro area CM are previously set to predetermined addresses and addresses of a predetermined bit number (byte number) from the predetermined addresses are ensured as the VRAM area VR and the command macro area CM. In the present embodiment, the top address of the VRAM area VR is set to a top address “0000H” of the working memory 33 and the addresses of “55296 bits (equal to the number of pixels)” from the top address are ensured as the VRAM area VR. The top address of the command macro area CM is set to “3C00H” and the addresses of “8 k bits” from the top address are ensured as the command macro area CM. Although known, “H” indicates a hexadecimal value.

The drawing control circuit 31 controls a pointer of the working memory 33 on the basis of the control command from the microcomputer 40, and executes and stops the command macro generated in the working memory 33. In more detail, when a CM-STA control command (see FIG. 2) is received from the microcomputer 40, the drawing control circuit 31 moves the pointer of the working memory 33 to the top address “3C00H” of the command macro area CM and starts the execution of the command macro from the top command of the command macro area CM. When a CM-CLR control command is received from the microcomputer 40, the drawing control circuit 31 returns the pointer of the working memory 33 to the top address “3C00H” of the command macro area CM and stops the execution of the command macro. When a CM-TOP control command is received from the microcomputer 40, the drawing control circuit 31 returns the pointer of the working memory 33 to the top address “0000H” of the working memory 33. When a CM-WR command is received from the microcomputer 40, the drawing control circuit 31 writes the command in any area of the command macro area CM of the working memory 33. The CM-WR control command includes write start offset data and write data.

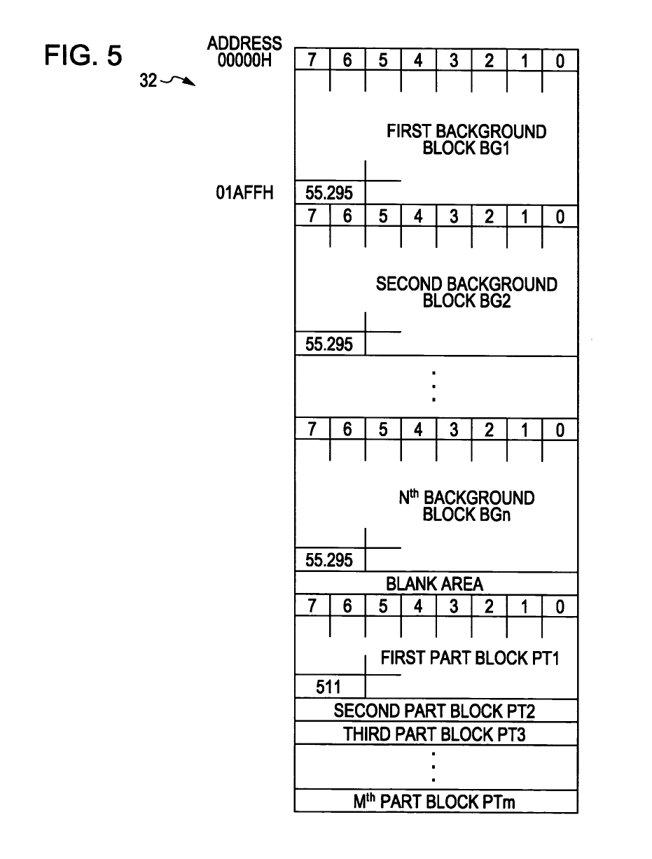

When an XF-BG2VR command or an XF-PT2VR command (see FIG. 3) written in the command macro area CM is read, the drawing control circuit 31 writes image material data of a specific address stored in the ROM 32 in a specific area of the VRAM area VR. Here, as shown in FIG. 5, a plurality of background blocks BG1 to BGn in which image material data of the background of the display unit of the wristwatch is previously written and a plurality of part blocks PT1 to PTm in which image material data indicating a time which will be partially displayed on the background is previously stored are previously stored in the ROM 32. The background blocks BG1 to BGn are composed of “55296 bits (equal to the number of pixels)” and the part blocks PT1 to PTm are composed of a predetermined number of bits. The XF-BG2VR command includes data for specifying a start address and a block size (byte number) of the ROM 32 for reading a predetermined background block BG from the ROM 32 and a start address of the VRAM area VR for writing the predetermined background block BG. The XF-PT2VR command includes data for specifying a start address and a block size (byte number) of the ROM 32 for reading a predetermined part block PT from the ROM 32 and a start address of the VRAM area VR for writing the predetermined part block PT.

When an XF-VR2EP command written in the command macro area CM is read, the drawing control circuit 31 outputs the image data D written in the VRAM area VR of the working memory 33 to the data line driving circuit 12.

When a POW command written in the command macro area CM is read, the drawing control circuit 31 sets a value of a power supply voltage on the basis of the POW command. When a DRV command written in the command macro area CM is read, the drawing control circuit 31 outputs a control signal for controlling the voltage applied to the common electrode to the common electrode control circuit 13 on the basis of the DRV command. When a LAST command written as a last command of the command macro is read from the command macro area CM, the drawing control circuit 31 stops the execution of the command macro.

As shown in FIG. 1, the timing control circuit 34 generates the various types of timing signals for controlling the scan line driving circuit 11 and the data line driving circuit 12 when the image data D is output from the working memory 33 to the data line driving circuit 12. The timing control circuit 34 outputs the generated various types of timing signals to the scan line driving circuit 11 and the data line driving circuit 12.

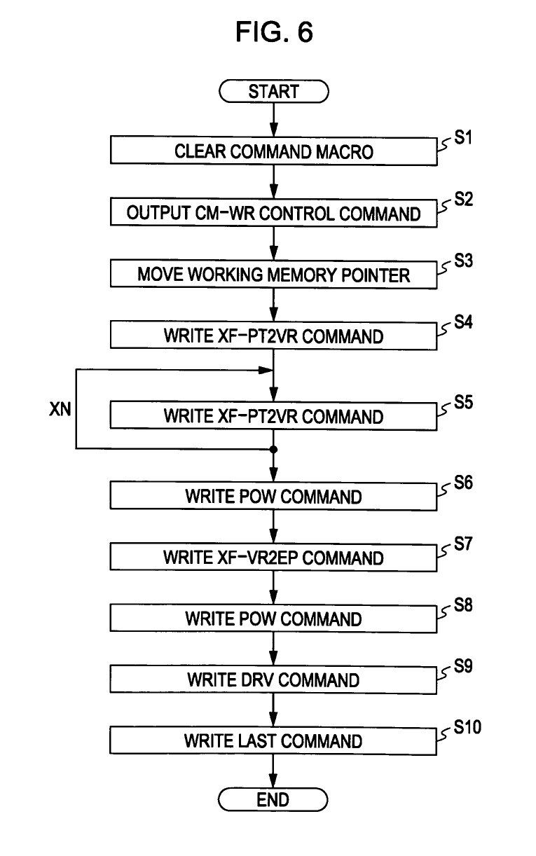

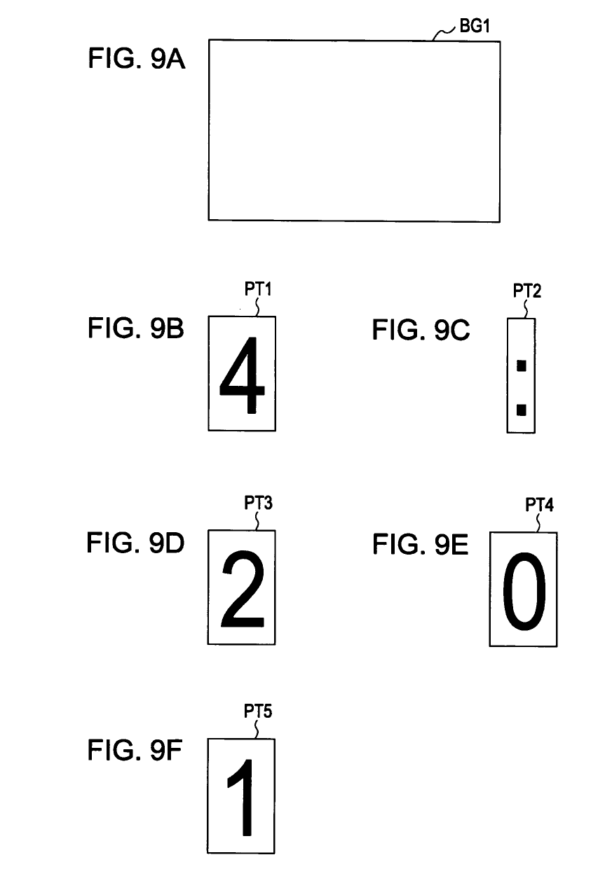

Next, a method of generating the command macro in the command macro area CM of the working memory 33 will be described with reference to FIG. 6. Here, as shown in FIG. 8A, a method of generating the command macro when an image B1, in which black characters “4:20” are formed in a white background, is displayed on the electrophoretic display panel 10 will be described. For convenience of description, as shown in FIG. 9, a first background block BG1 stored in the ROM 32 is set as the white background (see FIG. 9A), a first part block PT1 is set as a black character “4” (see FIG. 9B), and a second part block PT2 is set as a black character “:” (see FIG. 9C). A third part block PT3 stored in the ROM 32 is set as a black character “2” (see FIG. 9D) and a fourth part block PT4 is set as a black character “0” (see FIG. 9E).

As shown in FIG. 6, first, the microcomputer 40 outputs the CM-CLR control command stored in the microcomputer ROM 41 to the drawing control circuit 31. The drawing control circuit 31 moves the pointer of the working memory 33 to the top address “3C00H” of the command macro area CM on the basis of the CM-CLR control command (step S1). Accordingly, the various types of commands can be written from the top address of the command macro area CM of the working memory 33.

Next, the microcomputer 40 generates the CM-WR control command including a plurality of commands for displaying the image B1 as write data and outputs the CM-WR control command to the drawing control circuit 31 (step S2). The drawing control circuit 31 moves the pointer of the working memory 33 to a write start address on the basis of the write start offset data in the CM-WR control command (step S3). Here, as the write start offset data, the write start address of the command macro area CM is specified as a relative address from the address (here, “3C00H”) of the pointer of the current working memory 33. In the present example, since the pointer of the current working memory 33 becomes the write start address, the relative address (write start offset data) is set to “0”.

Next, the drawing control circuit 31 writes the write data included in the CM-WR control command from the address indicated by the pointer of the working memory 33, that is, the top address “3C00H” of the command macro area CM of the working memory 33 (steps S4 to S10). In the present example, the plurality of commands are input to the drawing control circuit 31 as the write data in the following sequence and the plurality of commands are written in the command macro area CM of the working memory 33 through the drawing control circuit 31.

That is, first, the XF-BG2VR (BG1) command for copying a predetermined background block (here, the first background block BG1) of the ROM 32 to the VRAM area VR of the working memory 33 is input to the drawing control circuit 31 as the write data. The drawing control circuit 31 writes the XF-BG2VR (BG1) command from the top address “3C00H” of the command macro area CM of the working memory 33 (step S4).

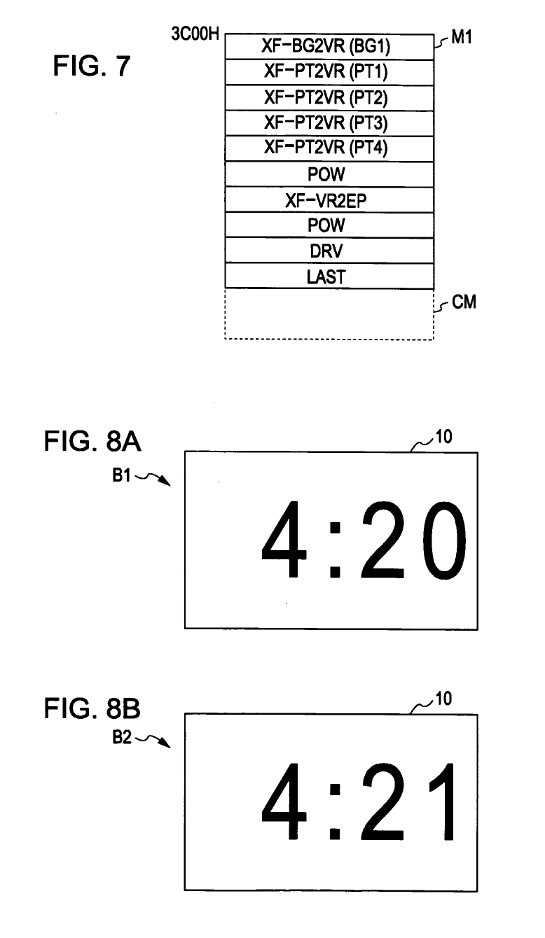

Subsequently, the XF-PT2VR commands for copying predetermined part blocks of the ROM 32 to the VRAM area VR of the working memory 33 are sequentially input to the drawing control circuit 31 as the write data. The drawing control circuit 31 sequentially writes the XF-PT2VR commands in the command macro area CM of the working memory 33 (step S5). In the present example, as shown in FIG. 7, the XF-PT2VR (PT1) command for copying the first part block PT1 is written from an address next to the address at which the XF-BG2VR (BG1) command is written in the command macro area CM. Next, the XF-PT2VR (PT2) command for copying the second part block PT2 is written from an address next to the address at which the XF-PT2VR (PT1) command is written in the command macro area CM. Similarly, the XF-PT2VR (PT3) command for copying the third part block PT3 and the XF-PT2VR (PT4) command for copying the fourth part block PT4 are sequentially written in the command macro area CM.

Subsequently, in the steps S6 to S10 shown in FIG. 6, the POW command, the XF-VR2EP command, the POW command, the DRV command and the LAST command are sequentially input to the drawing control circuit 31 as the write data. The drawing control circuit 31 sequentially writes the commands in the command macro area CM. Accordingly, as shown in FIG. 7, one command macro M1 composed of the plurality of commands is generated in the command macro area CM of the working memory 33.

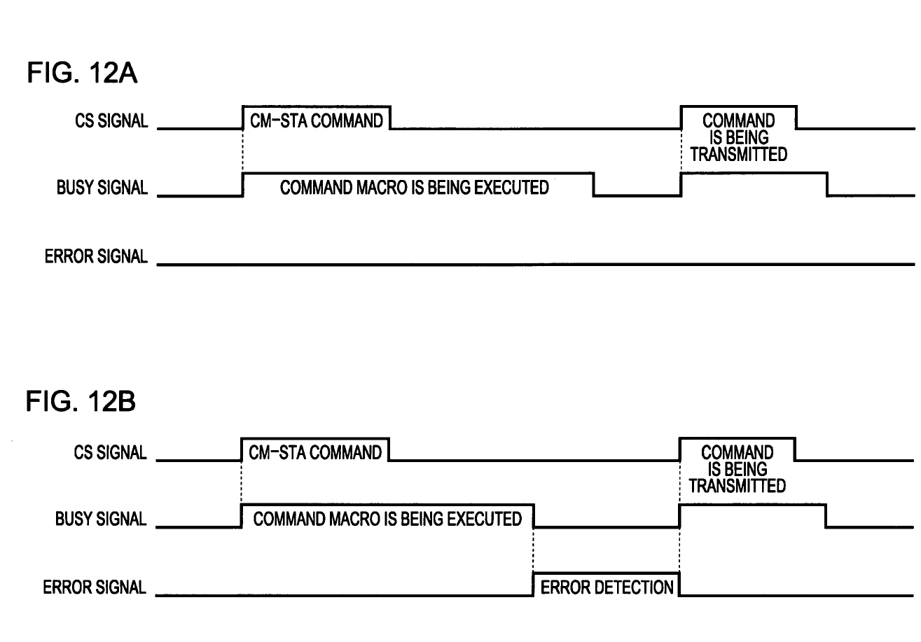

The pointer of the working memory 33 indicates an address next to a last address at which the write data is written, after the write data (the plurality of commands) from the microcomputer 40 is written. In the present embodiment, in order to specify an end of the write data, when the writing of the write data is completed, a CS signal (see FIG. 12) which allows the transmission of the command from the microcomputer 40 to the drawing control circuit 31 transitions to an inactive level (L level).

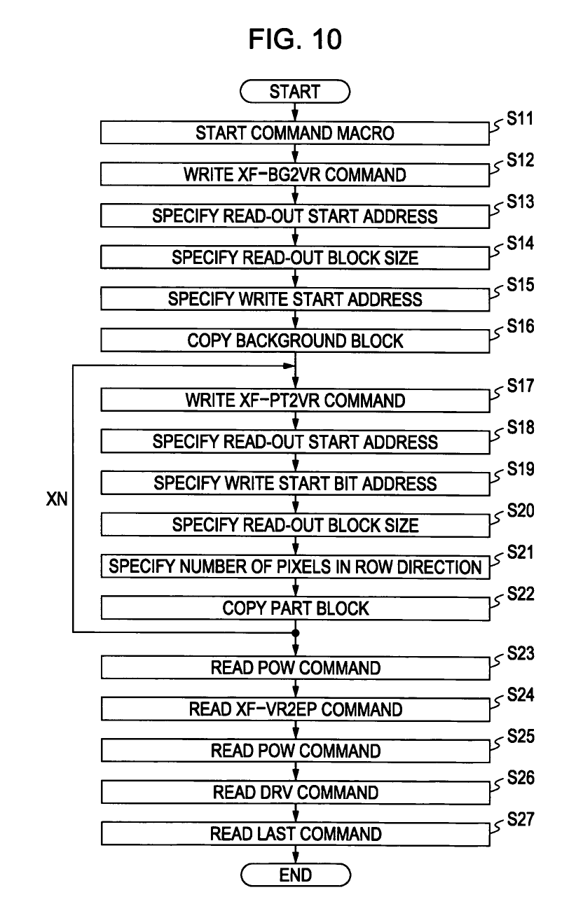

Next, a method of executing the generated command macro M1 and displaying the image B1 on the electrophoretic display panel 10 will be described with reference to FIG. 10. As shown in FIG. 10, first, the microcomputer 40 outputs the CM-STA control command stored in the microcomputer ROM 41 to the drawing control circuit 31. The drawing control circuit 31 moves the pointer of the working memory 33 to the top address “3C00H” of the command macro area CM (XF-BG2VR (BG1) command) and starts the execution of the command macro M1, on the basis of the CM-STA control command (step S11).

When the execution of the command macro M1 is started, first, the drawing control circuit 31 reads the XF-BG2VR (BG1) command written at the top address of the command macro area CM of the working memory 33 (step S12). Next, the drawing control circuit 31 specifies the top address of the predetermined background block BG (here, the first background block BG1) of the ROM 32 as a read-out start address, on the basis of the read XF-BG2VR command (step S13).

Next, the drawing control circuit 31 specifies the size of the first background block BG1 read from the ROM 32 by a byte number as a read-out block size, on the basis of the XF-BG2VR (BG1) command (step S14). Here, since the first background block BG1 is composed of 55296 bits, the drawing control circuit 31 specifies the read-out block size to 6912 (=55296/8) bytes.

Subsequently, the drawing control circuit 31 specifies the write start address of the working memory 33 for writing the first background block BG1 read from the ROM 32 on the basis of the XF-BG2VR (BG1) command (step S15). Here, the drawing control circuit 31 specifies the top address “0000H” of the VRAM area VR as the write start address.

When the specifying of the address is completed, the drawing control circuit 31 copies the image data having the read-out block size from the read-out start address in the ROM 32 to an area corresponding to the read-out block size from the write start address of the VRAM area VR of the working memory 33 (step S16). That is, the drawing control circuit 31 reads the first background block BG1 stored in the ROM 32 and writes the read first background block BG1 in the VRAM area VR of the working memory 33.

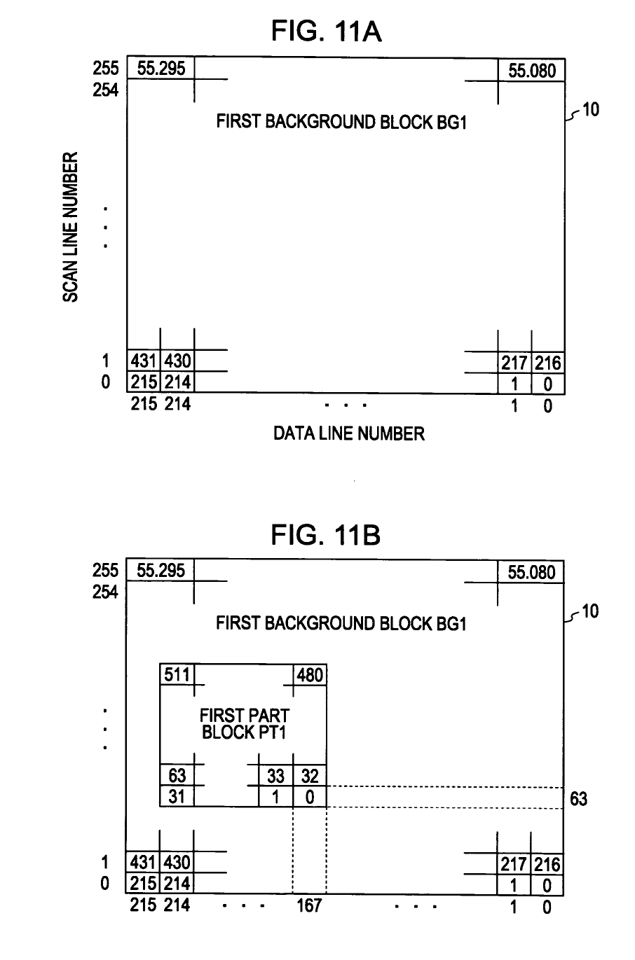

In a case where the first background block BG1 is output to the data line driving circuit 12 as the image data D, bits 0 to 55295 of the image data D (the first background block BG1) are transmitted to the respective pixels of the electrophoretic display panel 10, as shown in FIG. 11A. That is, the bit 0 of the image data D is transmitted to a pixel (0, 0) connected to the data line X0 and the scan line Y0 and the bits 1 to 215 are sequentially transmitted to the respective pixels in the row direction (left direction) from the pixel (0, 0). The bit 216 of the image data D is transmitted to a pixel (0, 1) connected to the data line X0 and the scan line Y1 and the bits 217 to 431 of the image data D are sequentially transmitted to the respective pixels in the left direction from the pixel (0, 1). Similarly, the bits 431 to 55295 of the image data are transmitted to the respective pixels.

Next, the drawing control circuit 31 reads the XF-PT2VR command (here, the XF-PT2VR (PT1) command) written in the command macro area CM of the working memory 33 (step S18). Next, the drawing control circuit 31 specifies the top address of the first part block PT1 in the ROM 32 as the read-out start address, on the basis of the read XF-PT2VR (PT1) command.

Subsequently, the drawing control circuit 31 specifies a write start bit address of the working memory 33 for writing the first part block PT1 read from the ROM 32, on the basis of the XF-PT2VR (PT1) command (step S19). In more detail, the drawing control circuit 31 specifies a bit address of the VRAM area VR corresponding to a pixel address (X, Y), at which the bit 0 of the first part block PT1 is arranged after transmission, as the write start bit address. Here, as shown in FIG. 11B, since the bit 0 of the first part block PT1 is desired to be arranged at a pixel (167, 63) of the electrophoretic display panel 10 after transmission, the drawing control circuit 31 writes and specifies the bit address of the VRAM area VR corresponding to the pixel (167, 63) as the start bit address.

Next, the drawing control circuit 31 specifies the size of the first part block PT1 read from the ROM 32 by a byte number on the basis of the XF-PT2VR (PT1) command (step S20). Here, since the first part block PT1 is composed of 512 bits, the drawing control circuit 31 specifies the read-out block size to 64 (−512/8) bytes.

Subsequently, the drawing control circuit 31 specifies the number of pixels in the row direction of the first part block PT1 after transmission to the electrophoretic display panel 10 by a byte number, on the basis of the XF-PT2VR (PT1) command (step S21). Here, as shown in FIG. 11B, since the number of pixels in the row direction of the first part block PT1 is 32 bits, the drawing control circuit 31 specifies the number of pixels in the row direction to 4 bytes.

When the specifying of the number of pixels is completed, the drawing control circuit 31 copies the first part block PT1 stored in the ROM 32 to an area corresponding to the read-out block size and the number of pixels in the row direction specified from the bit address of the VRAM area VR corresponding to the pixel (167, 63) (step S22).

The copying of the part block PT executed by the steps S17 to S22 is repeated by the number N of XF-PT2VR commands in the command macro M1. Since the command macro M1 has the XF-PT2VR (PT2) command, the XF-PT2VR (PT3) command and the XF-PT2VR (PT4) command in addition to the XF-PT2VR (PT1) command, the steps S17 to S22 are repeated four times. When the part blocks PT1 to PT4 are copied to a desired area of the VRAM area VR, the image data D1 for forming the image B1 (see FIG. 8A) is generated in the VRAM area VR.

Next, in a step S23 shown in FIG. 10, the drawing control circuit 31 reads the POW command written in the command macro area CM of the working memory 33 and sets the power supply voltage supplied to the pixel circuits 20 to a low voltage level on the basis of the POW command. The drawing control circuit 31 sets the power supply voltage to the low voltage level and reads the XF-VR2EP command written in the command macro area CM (step S24). Next, the drawing control circuit 31 outputs the image data D1 generated in the VRAM area VR of the working memory 33 to the data line driving circuit 12, on the basis of the XF-VR2EP command. At this time, the various types of timing signals are output from the timing control circuit 34 to the scan line driving circuit 11 and the data line driving circuit 12. The data line driving circuit 12 generates the data signals on the basis of the image data D1 received from the working memory 33 and outputs the generated data signals to the pixel circuits 20 connected to the scan line Y selected by the scan line driving circuit 11. Accordingly, the data signal are written in the memory circuits included in the pixel circuits 20 with the low voltage level.

Subsequently, the drawing control circuit 31 reads the POW command of the command macro area CM and sets the power supply voltage supplied to the pixel circuits 20 to a high voltage level on the basis of the POW command (step S25). Next, the drawing control circuit 31 reads the DRV command of the command macro area CM and outputs the control signal for controlling the voltage applied to the common electrode COM to the common electrode control circuit 13 on the basis of the DRV command (step S26). Accordingly, a voltage difference occurs between the pixel electrodes P in all the pixel circuits 20 and the common electrode COM such that the electrophoretic particles move to desired electrodes in each pixel. As a result, the image B1 based on the image data D1 is displayed on the electrophoretic display panel 10.

The drawing control circuit 31 reads the LAST command of the command macro area CM and completes the command macro M1. The drawing control circuit 31 outputs a completion signal indicating that the process based on the various types of commands is completed to the microcomputer 40, on the basis of the LAST command.

As shown in FIG. 12A, the drawing control circuit 31 sets a busy signal indicating that the command macro M1 is executed with respect to the microcomputer 40 to an active level (H level) while the command macro M1 is executed. When the busy signal is at the active level, for example, the transmission of the command from the microcomputer 40 is impossible. That is, the microcomputer 40 transmits a new command to the drawing control circuit 31 when the busy signal transitions to the inactive level (L level). The busy signal transitions to the inactive level when the LAST command is executed. When an error is detected while the command macro M1 is executed, the drawing control signal 31 transitions the busy signal to the inactive level and transitions the error signal to the active level (H level), as shown in FIG. 12B. The error signal which is at the active level is cleared and transitions to the inactive level (L level) when a next command is executed.

Next, a method of correcting some command of the command macro M1 will be described. Here, a method of correcting the command macro when the image B1 is changed to an image B2 in which black characters “4:21” are formed in a white background as shown in FIG. 8B will be described. The change of the display from the image B1 to the image B2 is performed one minute after the image B1 is displayed. Accordingly, the below-described correction of the command macro is performed before the change of the display. For convenience of description, as shown in FIG. 9F, a fifth part block PT5 stored in the ROM 32 is set to a black character “1”.

As can be apparent from the comparison between the image B1 and the image B2 shown in FIG. 8, the image B1 and the image B2 are different from each other in only the black characters “0” and “1” and are equal to each other in the other images. Accordingly, in the present embodiment, in the generated command macro M1, the XF-PT2VR (PT4) command for copying the fourth part block PT4 corresponding to the black character “0” to the working memory 33 is corrected to the XF-PT2VR (PT5) command for copying the fifth part block PT5 corresponding to the black character “1” to the working memory 33.

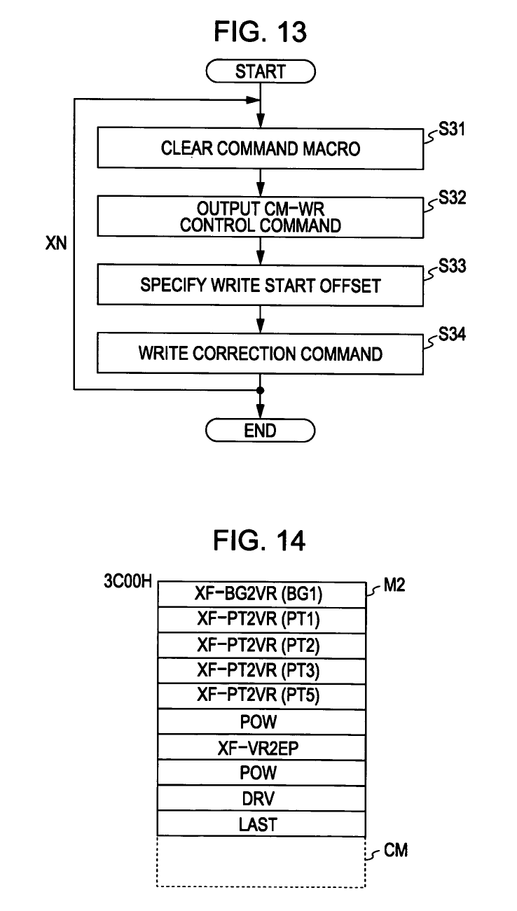

In more detail, as shown in FIG. 13, first, the microcomputer 40 outputs the CM-CLR control command stored in the microcomputer ROM 41 to the drawing control circuit 31. The drawing control circuit 31 moves the pointer of the working memory 33 to the top address “3C00H” of the command macro area CM, on the basis of the CM-CLR control command (step S31).

Next, the microcomputer 40 generates the CM-WR control command including the XF-PT2VR (PT5) for copying the fifth part block PT5 (see FIG. 9F) to the VRAM area VR of the working memory 33 as the write data and outputs the CM-WR control command to the drawing control circuit 31 (step S32). The drawing control circuit 31 moves the pointer of the working memory 33 to the top address of the command macro area CM, in which the XF-PT2VR (PT4) command is written, on the basis of the write start offset data in the CM-WR control command.

Next, the drawing control circuit 31 writes the write data composed of a predetermined command (here, the XF-PT2VR (PT5) command) included in the CM-WR control command from the address indicated by the pointer of the working memory 33 (step S34). In the present example, as shown in FIG. 14, the drawing control circuit 31 overwrites the XF-PT2VR (PT5) command in an area in which the XF-PT2VR (PT4) command of the command macro area CM of the working memory 33 is written. Accordingly, in the command macro area CM of the working memory 33, a command macro M2 having a configuration different from that of the command macro M1 is generated. Even in a case where a plurality of commands in the command macro M1 is corrected, the steps S30 to S33 are repeatedly executed so as to generate a new command macro.

The command macro M2 is executed by the flowchart of FIG. 10 such that image data D2 for forming the image B2 (see FIG. 8B) is generated in the VRAM area VR and the image B2 is displayed on the electrophoretic display panel 10 on the basis of the image data D2.

According to the above-described embodiment, the following effects can be obtained.

(1) According to the present embodiment, the drawing control circuit 31 generates the command macro M1 composed of the plurality of commands in the command macro area CM of the working memory 33 according to the CM-WR control command from the microcomputer 40 and executes the command macro M1 according to the CM-STA control command as a first control instruction signal from the microcomputer 40.

The microcomputer 60 of the known electrophoretic display device outputs predetermined commands to the drawing control circuit 31. The drawing control circuit 51 performs processes based on the predetermined commands and outputs a completion signal indicating the completion of the processes to the microcomputer 60. The microcomputer 60 receives the completion signal and outputs a next command to the drawing control circuit 51. That is, the known microcomputer 60 should receive ten completion signals from the drawing control circuit 51, for example, in order to perform the process based on all the commands (ten commands) configuring the command macro M1.

In contrast, in the present embodiment, all the commands configuring the command macro M1 are continuously executed. Accordingly, in order to perform all the processes based on the command macro M1, the microcomputer 40 may receive only one completion signal indicating that the command macro M1 is completed. Accordingly, since the number of times of input of the completion signal to the microcomputer 40 is reduced, the load of the microcomputer 40 is reduced. Further, a time for changing an image can be shortened.

(2) According to the present embodiment, the drawing control circuit 31 continuously executes processes based on all the commands configuring the command macro M1. Accordingly, an interval between the execution of a process based on a predetermined command and the execution of a process based on a next command is more shortened compared with a case where a next command is output whenever a process based on a command are completed. For example, the interval between the execution of the process based on the XF-BG2VR (BG1) command and the execution of the process based on the XF-PT2VR (PT1) is shortened. As a result, the generation of the image data D1 or the display of the image B1 based on the image data D1 can be smoothly performed.

(3) According to the present embodiment, the command macro M1 composed of a series of commands for displaying the image B1 based on the image data D1 on the electrophoretic display panel 10 is, for example, generated in the command macro area CM and the CM-STA control command for starting the execution of the command macro M1 is output from the microcomputer 40. Accordingly, when the CM-STA control command is output from the microcomputer 40, all the commands for displaying the image B1 are continuously executed. Accordingly, when various types of processes for displaying the image B1 are executed in the drawing control circuit 31, the microcomputer 40 can execute another process. At this time, for example, the power consumption of the electrophoretic display device 1 can be reduced by setting the microcomputer 40 to a sleep state which is a low power consumption mode.

(4) According to the present embodiment, the drawing control circuit 31 writes a predetermined command in any area of the command macro area CM on the basis of the CM-WR control command as a second control instruction signal. In the present example, the XF-PT2VR (PT4) command of the command macro M1 which is first written is rewritten with the XF-PT2VR (PT5) command so as to generate the command macro M2. Accordingly, some of the commands configuring the command macro are output from the microcomputer 40 so as to generate a new command macro, thereby changing the display of the image. As a result, the load of the microcomputer 40 can be remarkably reduced. In the case where the next command is output whenever the process based on the command is completed, all the commands configuring the command macro M2 need to be output from the microcomputer 60 when the display is changed from the image B1 to the image B2.

### Second Embodiment

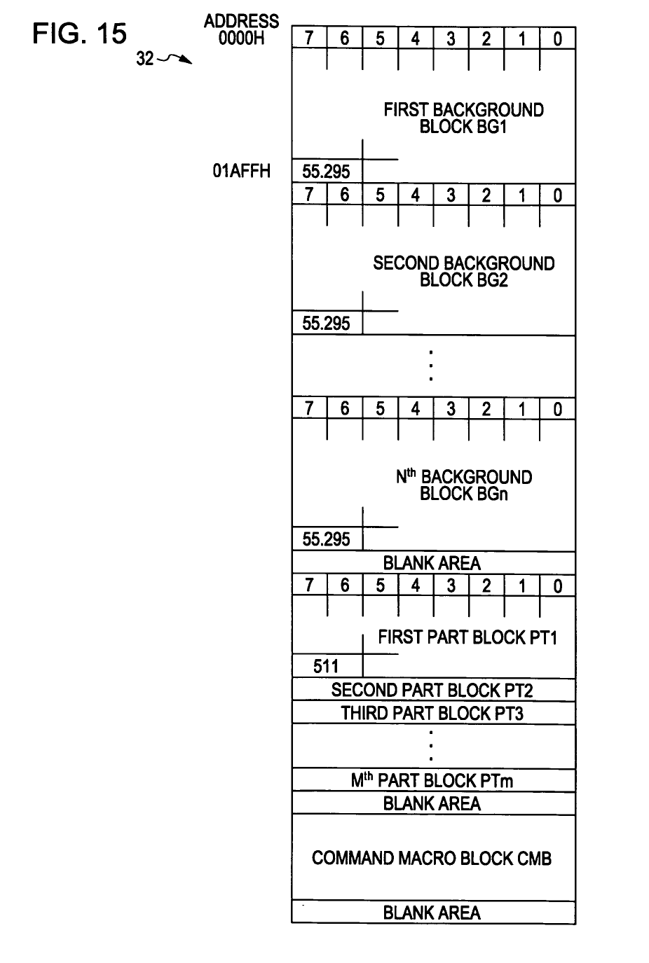

Hereinafter, an electrophoretic display device according to a second embodiment of the invention will be described with reference to FIGS. 15 to 19. The electrophoretic display device according to the present embodiment is different from the first embodiment in a memory structure of the ROM 32 and the type of the control command stored in the microcomputer ROM 41. Hereinafter, the present embodiment will be described, concentrating on differences from the first embodiment. The electrophoretic display device according to the present embodiment includes the substantially same configuration as the electrophoretic display device 1 according to the first embodiment shown in FIG. 1.

As shown in FIG. 15, the ROM 32 of the drawing circuit 30 includes a plurality of background blocks BG1 to BGn, a plurality of part blocks PT1 to PTm, and a command macro block CMB for storing the plurality of command macros (for example, command macros M1 and M2) composed of the plurality of commands described in the first embodiment.

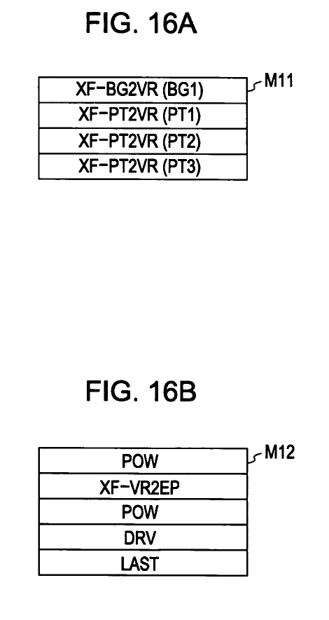

In the present embodiment, the plurality of command macros for displaying various images on an electrophoretic display panel 10 are previously generated and stored in the command macro block CMB which is newly added. Command macros (division command macros) obtained by dividing the command macros in plural are stored in the command macro block CMB, in addition to the command macros including all commands for displaying desired images, such as the command macros M1 and M2. As shown in FIG. 16, a division command macro M11 and a division command macro M12 obtained by dividing the command macro M1 by two are stored in the command macro block CMB. The XF-PT2VR (PT4) command in the command macro M1 is not included in the division command macros M11 and M12. Here, the XF-PT2VR (PT4) command omitted in the division command macros M11 and M12, for example, corresponds to data which frequently varies with the elapse of time. The XF-PT2VR (PT4) command or the XF-PT2VR (PT5) command is stored in the microcomputer ROM 41.

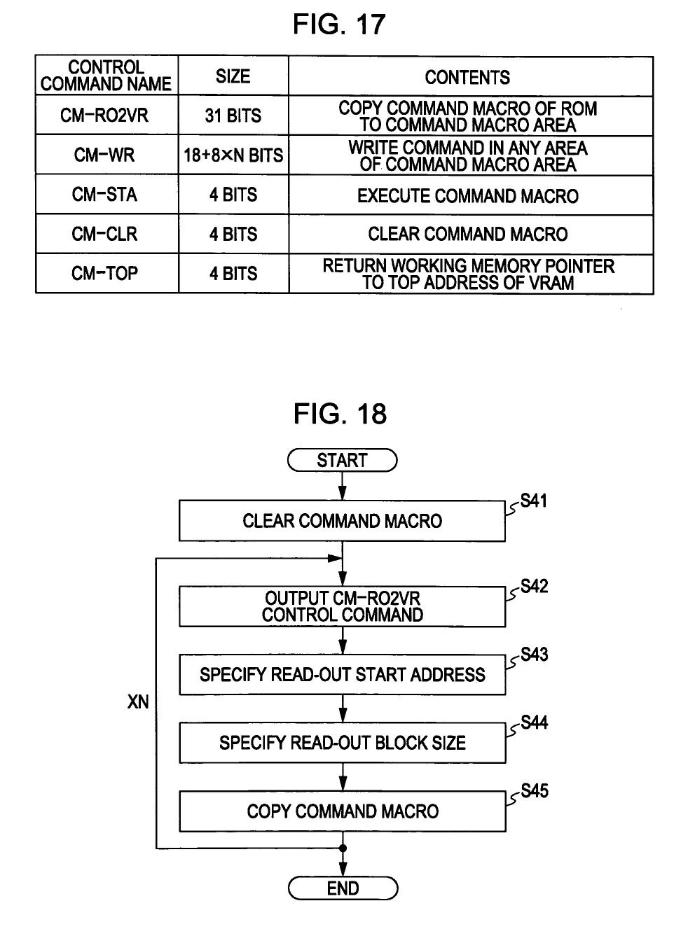

As shown in FIG. 17, the CM-RO2VR control command is stored in the microcomputer ROM 41, in addition to the four control commands described in the first embodiment. The CM-RO2VR control command is used to copy any command macro stored in the command macro block CMB of the ROM 32 to any area of the command macro area CM of the working memory 33. The CM-RO2VR control command includes a read-out start address of the ROM 32 and a block size of the command macro read from the ROM 32.

Next, a method of generating the command macro using the CM-RO2VR control command will be described with reference to FIG. 18. Here, similar to the first embodiment, a case where the image B1 is displayed on the electrophoretic display panel 10 will be described.

As shown in FIG. 18, first, the microcomputer 40 outputs the CM-CLR control command stored in the microcomputer ROM 41 to the drawing control circuit 31. The drawing control circuit 31 moves the pointer of the working memory 33 to the top address “3C00H” of the command macro area CM on the basis of the CM-CLR control command (step S41).

Next, the microcomputer 40 generates a CM-RO2VR (M1) control command for copying the command macro M1 of the ROM 32 to the command macro area CM of the working memory 33 and outputs the CM-RO2VR (M1) control command to the drawing control circuit 31 (step S42).

The drawing control circuit 31 specifies the top address of the command macro M1 stored in the command macro block CMB of the ROM 32 as a read-out start address on the basis of the CM-RO2VR (M1) control command (step S43). Next, the drawing control circuit 31 specifies the size of the CM-RO2VR (M1) control command by a byte number as a read-out block size (step S44).

When the specifying of the size is completed, in a step S45, the drawing control circuit 31 writes the command macro (here, the command macro M1) corresponding to the read-out block size from the read-out start address of the ROM 32 in an area corresponding to the read-out block size from the address (here, “3C00H”) indicated by the pointer of the working memory 33 (step S45). Accordingly, the command macro M1 for displaying the image B1 on the electrophoretic display panel 10 is written in the command macro area CM of the working memory 33. In a case where a plurality of command macros (division command macros) are written in the command macro area CM of the working memory 33 so as to generate one command macro, the steps S42 to S45 are repeatedly performed.

The command macro M1 is executed by the flowchart of FIG. 10 such that the image data D1 for forming the image B1 (see FIG. 8A) is generated in the VRAM area VR and the image B1 is displayed on the electrophoretic display panel 10 on the basis of the image data D1.

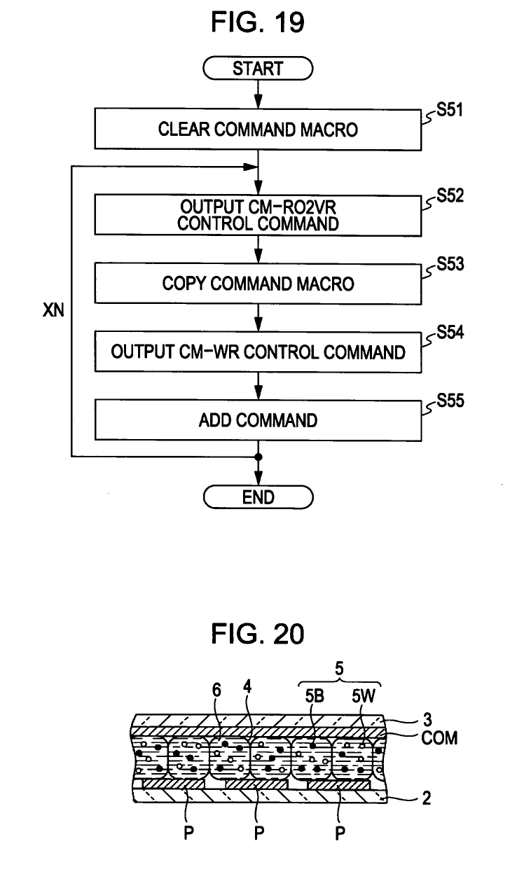

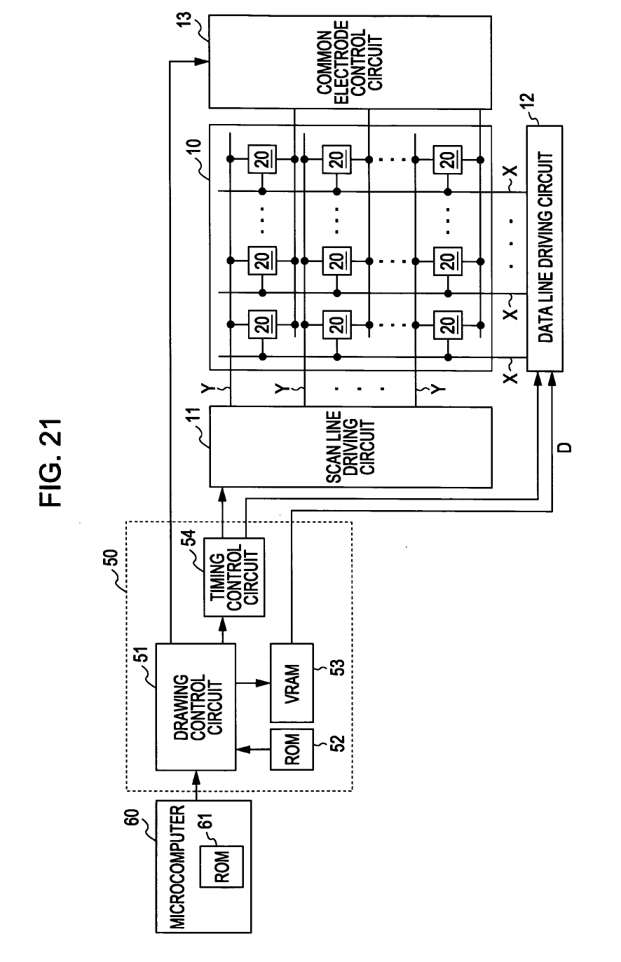

Next, a method of generating the command macro using the CM-RO2VR control command and the CM-WR control command will be described with reference to FIG. 19. Similar to the first embodiment, a case of displaying the image B1 on the electrophoretic display panel 10 will be described.

As shown in FIG. 19, first, in steps S51 to S53, the same processes as the steps S41 to S45 of FIG. 18 are performed and a predetermined command macro is copied from the command macro block CMB of the ROM 32 to the command macro area CM of the working memory 33. In the present example, the division command macro M11 of the command macro block CMB is written in the command macro area CM by performing the steps S51 to S53.

Next, the microcomputer 40 generates the CM-WR control command including a XF-PT2VR (PT4) command for writing the fourth part block PT4 (see FIG. 9E) in the VRAM area VR of the working memory 33 as the write data and outputs the CM-WR control command to the drawing control circuit 31 (step S54). The relative address of write start offset data in the CM-WR control command is set to “0”. Accordingly, the drawing control circuit 31 does not move the pointer of the working memory 33.

Next, the drawing control circuit 31 writes the XF-PT2VR (PT4) command included in the CM-WR control command from the address indicated by the pointer of the working memory 33 (step S55). That is, the XF-PT2VR (PT4) command is written after the division command macro M11 which is first written in the command macro area CM of the working memory 33.

Subsequently, the steps S52 and S53 are performed such that the division command macro M12 is written after the XF-PT2VR (PT4) command in the command macro area CM of the working memory 33. Accordingly, when the division command macro M12 is written in the command macro area CM of the working memory 33, the command macro M1 shown in FIG. 7 is generated in the command macro area CM.

Although the command macro M1 is generated in the command macro area CM of the working memory 33 by any one of the methods shown in FIGS. 18 and 19, similar to the correcting method of the first embodiment shown in FIG. 13, it is possible to correct some command of the command macro M1 using the CM-WR control command. That is, for example, by outputting the CM-WR (PT5) control command for correcting the XF-PT2VR (PT4) command to the XF-PT2VR (PT5) command is output from the microcomputer 40 to the drawing control circuit 31, it is possible to change the command macro M1 of the command macro area CM to the command macro M2.

According to the above-described embodiment, the following effects are obtained in addition to the effects (1) to (4) of the first embodiment.

(5) According to the present embodiment, the plurality of command macros composed of the plurality of commands are previously stored in the ROM 32. The drawing control circuit 31 writes the command macro (for example, the command macro M1) stored in the ROM 32 in the command macro area CM on the basis of the CM-RO2VR control command as a third control instruction signal from the microcomputer 40. Accordingly, a series of commands for displaying the image B1 on the electrophoretic display panel 10 can be written in the command macro area CM by one CM-RO2VR control command from the microcomputer 40. Accordingly, since the amount of data output from the microcomputer 40 to the drawing control circuit 31 can be remarkably reduced, it is possible to remarkably reduce the load of the microcomputer 40.

(6) According to the present embodiment, the drawing control circuit 31 writes the predetermined command in any area of the command macro area CM on the basis of the CM-WR control command as the second control instruction signal. In the present example, the XF-PT2VR (PT4) command is further written after the XF-PT2VR (PT3) of the division command macro M11 which is first written. Accordingly, it is possible to improve a freedom degree of the method of generating the command macro.

(7) According to the present embodiment, the command (for example, the XF-PT2VR (PT4) command) which frequently varies with time is not included in the command macro and is added before and after the division command macros M11 and M12 like the generating method shown in FIG. 19. Accordingly, since the command macro for displaying an image having every pattern does not need to be stored in the ROM 32, it is possible to suppress the increase of the memory size of the ROM 32.

### Other Embodiments

The above-described embodiments may be embodied by the following aspects.

In the above-described embodiments, when the command macro is corrected, the command macro is cleared, the pointer of the working memory 33 is moved to the top address of the command macro area CM, and the write start offset of the CM-WR control command is specified as the relative address from the top address. The invention is not limited thereto and, after a previous command macro is executed, the relative address from the address indicated by the pointer of the working memory 33 may be written and specified as the start offset and the command macro may be corrected.

Alternatively, the pointer of the working memory 33 may be moved to the top address of the working memory 33 by the CM-TOP control command, the absolute address of the working memory 33 may be written and specified as the start offset, and the command macro may be corrected.

In the second embodiment, the XF-PT2VR (PT4) command or the XF-PT2VR (PT5) command corresponding to the data (image data or voltage data) which frequently varies with the elapse of time is stored in the microcomputer ROM 41. The invention is not limited thereto and the command may be previously stored in the ROM 32. In this case, it is preferable that the XF-PT2VR (PT4) command or the XF-PT2VR (PT5) command stored in the ROM 32 can be written in the command macro area CM by the CM-RO2VR command. Accordingly, since the storage of the command in the microcomputer ROM 41 having a small memory size can be omitted, it is possible to reduce the amount of data of the microcomputer ROM 41. In a case of previously storing all commands or command macros in the ROM 32, the commands do not need to be stored in the microcomputer ROM 41.

The command macros or the commands which are previously stored in the ROM 32 may be written in any area of the command macro area CM by the CM-RO2VR control command of the second embodiment. Accordingly, some command of the command macro written in the command macro area CM may be corrected or the command may be added to the command macro, by the command macros or the commands stored in the ROM 32. Thus, it is possible to improve the freedom degree of the method of generating the command macro.

Although all the commands configuring the command macro M1 are included in one CM-WR control command as the write data in the method of generating the command macro shown in FIG. 6 of the first embodiment, the number of commands included as the write data of the CM-WR control command is not specially limited. For example, two commands may be included as the write data of one CM-WR control command. In this case, in order to generate the command macro M1, five CM-WR control commands are output from the microcomputer 40 to the drawing control circuit 31.

In the first embodiment, all the commands configuring the command macro M1 are written in the command macro area CM and then the command macro M1 is executed. The invention is not limited thereto and the command macro may be executed in each command macro composed of some of the plurality of commands configuring the command macro M1, like the division command macro M11 shown in the second embodiment. In this case, it is preferable that the LAST command is added to the end of each command macro.

In the method of generating the command macro of the second embodiment shown in FIG. 19, the command macro M1 is generated by the division command macros M11 and M12 and the XF-PT2VR (PT4) command and then the command macro M1 is executed. The invention is not limited thereto and, for example, the division command macro M11 may be written in the command macro area CM, the division command macro M11 may be executed, the XF-PT2VR (PT4) command may be written in the command macro area CM, and the XF-PT2VR (PT4) command may be executed. Thereafter, the division command macro M12 may be written in the command macro area CM and the division command macro M12 may be executed. In this case, it is preferable that the LAST command is added to the ends of the division command macros M11 and M12 and the XF-PT2VR (PT4) command.

Although, in the correction of the command macro shown in FIG. 13, the XF-PT2VR (PT4) in the command macro M1 is corrected in the first embodiment, the corrected command is not limited thereto. For example, the POW command or the DRV command may be corrected. That is, other commands may be rewritten in a command macro which is first written and a command macro which is next written.

Although the copying of the command macro according to the CM-RO2VR control command is performed after the command macro is cleared in the method of generating the command macro of the second embodiment shown in FIG. 19, the writing of the command according to the CM-WR control command may be performed.

In the above-described embodiments, when the command is written in the command macro area CM according to the CM-WR control command, the CS signal transitions to the inactive level (L level) so as to specify the end of the write data. The invention is not limited thereto and the end of the write data may be specified by, for example, including the size of the write data in the CM-WR control command.

The image data D1 and D2 and the images B1 and B2 of the above-described embodiments are not specially limited. The sequence of the commands written in the command macro area CM of the above-described embodiments is not specially limited.

The types of the plurality of commands configuring the command macros M1 and M2 of the above-described embodiments are not specially limited.

Although the size of the background block BG1 to BGn stored in the ROM 32 is configured by the number of bits equal to the number of pixels in the above-described embodiments, the size of the background blocks BG1 to BGn may be configured by any number of bits.

Although the working memory 33 includes the VRAM area VR and the command macro area CM in the above-described embodiments, the invention is not limited thereto and a first working memory having the VRAM area VR and a second working memory having the command macro area CM may be separately provided, instead of the working memory 33.

Although the working memory 33 is configured by the SRAM in the above-described embodiments, the working memory 33 is not specially limited if the memory is a rewritable memory. For example, the working memory 33 may be configured by a DRAM.

The memory area of the working memory 33 of the above-described embodiments is not specially limited. That is, the top address of the command macro area CM or the VRAM area VR may be set to any address.

The size of the command macro area CM of the working memory 33 of the above-described embodiments is not specially limited.

Although the commands are embodied as the instruction signal from the microcomputer 40 in the above-described embodiments, the setting of a register or a program may be embodied as the instruction signal.

The number of data lines, the number of scan lines and the number of pixel circuits of the above-described embodiments are not specially limited.

Although the pixel circuits 20 arranged in the electrophoretic display panel 10 are embodied as the pixel circuit having the memory circuit in the above-described embodiments, the invention is not limited thereto and each pixel circuit may be changed to a pixel circuit composed of a switching element, a pixel electrode and a hold capacitor connected to the pixel electrode in parallel.

Although the electrophoretic display device 1 is embodied as the electro-optical display device in the above-described embodiments, the invention is not limited thereto and, for example, a liquid crystal display device or an organic EL display device may be embodied.

Although the electro-optical display device applies to the wristwatch including only the microcomputer having the low processing capability in the above-described embodiments, the electro-optical display device is applicable to all electronic apparatuses, regardless of the processing capability of the mounted microcomputer.

What is claimed is:

1. A drawing device of an electro-optical display device which includes a drawing circuit for outputting image data to a driving circuit for driving electro-optical elements of a display unit for displaying an image based on the image data, and a control circuit for controlling the drawing circuit, wherein:
the drawing circuit includes a first memory in which a plurality of image material data is previously stored, a first working memory having a working area in which the image data composed of at least one image material data is generated, a second working memory having a command information area in which a command signal for instructing execution of a predetermined process is written, and a drawing control circuit which writes the command signal in the command information area and generates command information composed of a plurality of command signals in the command information area, and
the control circuit outputs a first control command signal for executing the command information to the drawing control circuit.

2. The drawing device of the electro-optical display device according to claim 1, wherein the drawing control circuit writes the command signal received from the control circuit in the command information area, on the basis of a second control command signal received from the control circuit.

3. The drawing device of the electro-optical display device according to claim 2, wherein the drawing control circuit writes the command signal from the control circuit in any area of the command information area, on the basis of the second control command signal.

4. The drawing device of the electro-optical display device according to claim 1, wherein:
the plurality of command signals are previously stored in the first memory, and
the drawing control circuit writes the predetermined command signal stored in the first memory in the command information area, on the basis of a second control command signal received from the control circuit.

5. The drawing device of the electro-optical display device according to claim 4, wherein the drawing control circuit writes the predetermined command signal stored in the first memory in any area of the command information area, on the basis of the second control command signal.

6. The drawing device of the electro-optical display device according to claim 1, wherein:
plural pieces of command information which are previously generated are previously stored in the first memory, and
the drawing control circuit writes the predetermined command information stored in the first memory in the command information area, on the basis of a third control command signal received from the control circuit.

7. The drawing device of the electro-optical display device according to claim 6, wherein the drawing control circuit writes the predetermined command information stored in the first memory in any area of the command information area, on the basis of the third control command signal.

8. The drawing device of the electro-optical display device according to claim 1, wherein the control circuit outputs the first control command signal after the command information composed of all the command signals for displaying a predetermined image is generated in the command information area.

9. The drawing device of the electro-optical display device according to claim 1, wherein the first working memory and the second working memory are configured by one working memory.

10. The drawing device of the electro-optical display device according to claim 1, wherein the display unit includes a plurality of scan lines, a plurality of data lines, and a plurality of pixel circuits which are provided in correspondence with intersections between the plurality of scan lines and the plurality of data lines and respectively include the electro-optical elements.

11. The drawing device of the electro-optical display device according to claim 1, wherein the electro-optical element is a dispersion system including electrophoretic particles.

12. A drawing method of an electro-optical display device which includes a display unit which includes electro-optical elements and displays an image based on image data, a driving circuit for driving the display unit, a drawing circuit for outputting the image data to the driving circuit, and a control circuit for controlling the drawing circuit, wherein:
a drawing control circuit of the drawing circuit writes a command signal for instructing execution of a predetermined process in a command information area of a working memory of the drawing circuit, and generates command information composed of a plurality of command signals in the command information area; and
the control circuit outputs a first control command signal for executing the command information to the drawing control circuit.

13. The drawing method of the electro-optical display device according to claim 12, wherein the drawing control circuit writes the command signal received from the control circuit in the command information area, on the basis of a second control command signal received from the control circuit.

14. The drawing method of the electro-optical display device according to claim 13, wherein the drawing control circuit writes the command signal from the control circuit in any area of the command information area, on the basis of the second control command signal.

15. The drawing method of the electro-optical display device according to claim 12, wherein the drawing control circuit writes the predetermined command signal, which is previously stored in a first memory of the drawing circuit, in the command information area, on the basis of a third control command signal received from the control circuit.

16. The drawing method of the electro-optical display device according to claim 12, wherein:
plural pieces of command information composed of the plurality of command signals are previously stored in a first memory of the drawing circuit, and
the drawing control circuit writes the predetermined command information stored in the first memory in the command information area, on the basis of a third control command signal received from the control circuit.

17. An electro-optical display device comprising the drawing device according to claim 1.

18. An electronic apparatus comprising the electro-optical device according to claim 17.
